(19) United States
(12) Patent Application Publication
(10) Pub. No.: US 2005/0273514 A1
(43) Pub. Date: Dec. 8, 2005

(54) System and method for automated and optimized file transfers among devices in a network

(76) Inventors: Ray Milkey, Los Altos, CA (US); Srikanth Subramaniam, San Jose, CA (US); John C. Ruttenberg, Waban, MA (US); Walter D. Lichtenstein, Belmont, MA (US); David Lemke, Mountain View, CA (US); Ashfaq A. Munshi, Los Altos Hills, CA (US); Luis O. Rojas, El Granada, CA (US); Fouad A. Tobagi, Los Altos, CA (US)

Correspondence Address: CARR & FERRELL LLP, 2200 GENG ROAD, PALO ALTO, CA, 94303, US

(21) Appl. No.: 09/852,464

(22) Filed: May 9, 2001

Related U.S. Application Data
(60) Provisional application No. 60/257,602, filed on Dec. 22, 2000.
(60) Provisional application No. 60/257,654, filed on Dec. 22, 2000.

(51) Int. Cl. G06F 15/16

(52) U.S. Cl. 709/232; 709/228

(57) ABSTRACT

A system for automated and optimized file transfers among devices in a network comprises a client configured to request a file transfer, a server configured to transfer the requested file to the client, and a scheduling module configured to schedule delivery of the file to the client. The scheduling module preferably schedules the delivery of the file to be completed by a deadline. In an alternate embodiment, the file is transferred to a device in the network that did not send the request. The file transfer may be requested by a user at the client or may be requested by a pre-fetch module of the client.

### CROSS-REFERENCE TO RELATED APPLICATIONS

This application is related to, and claims the benefit of, U.S. Provisional Patent Application No. 60/257,602, entitled “System for Automated and Optimized File Transfers Among Computers over a Network,” filed Dec. 22, 2000, and U.S. Provisional Patent Application No. 60/257,654, entitled “System and Method for Scheduling Data Transfers Through a Network,” filed Dec. 22, 2000. This application is also related to U.S. patent application Ser. No. ______, entitled “System and Method for Scheduling Data Transfers Through a Network,” filed on ______, and U.S. patent application Ser. No. ______, entitled “System and Method for Controlling Data Transfer Rates on a Network,” filed on ______. The subject matter of the related applications is hereby incorporated by reference. The related applications are commonly assigned.

### FIELD OF THE INVENTION

This invention relates generally to electronic networks and more particularly to a system and method for automated and optimized file transfers among devices in a network.

### BACKGROUND OF THE INVENTION

Over the past few years, the Internet and other networks have experienced a large amount of growth, both in the number and types of services provided and the number of users. People use the Internet to shop for things as diverse as groceries and cars, stay informed of current events, earn a college degree, pay bills, manage their investment portfolio, and run their business. The Internet is also a source for entertainment, including downloadable music and streaming audio and video.

As use of the Internet and other networks becomes more prevalent, users are requiring better and faster service. Slow dial-up connections are being replaced by broadband connections such as digital subscriber line (DSL) and cable modem. However, even broadband connections have limitations. For instance, the distance between the client and the central office affects the performance of a DSL connection, and the number of users that share a particular cable affects the performance of a cable modem connection.

For typical Internet ‘surfing’ activities, these limitations are not usually problematic. However, for other activities like downloading large software files or streaming video, the limitations of broadband connections become more apparent. Streaming video typically requires that the path through the network have the necessary resources available to support the data stream. If a large number of users are active on a cable connection, the connection may not have sufficient bandwidth to adequately support a video stream. Also, any situation that compromises the continuity of the data stream, such as a change in the path through the network, may degrade the quality of the video as seen by the user.

Streaming video also has a limitation in that a copy of the video file is not saved at the client. Thus, each time a user wishes to view the video it must be transferred from the source. Streaming video does not provide opportunities for sales of video files, such as DVD movies, with delivery over the Internet.

Other transfers of data files are saved at the client, for example software programs. Even with a broadband connection, downloading large program files takes a significant amount of time during which the user is typically present to monitor the process. The inconvenience of monitoring the downloading process may deter some users from streaming large data files from a server. Thus, there is a need for an improved system and method for delivering data files to devices in a network.

### SUMMARY OF THE INVENTION

The system of the invention includes software modules configured to deliver content from multiple sources to multiple destinations in an electronic network. The sources include servers and intermediate caches. The destinations include clients implemented as general-purpose computers and set-top boxes. Each device in the network may act as a server for certain content and as a client for other content. The content preferably includes large digital files such as video or software programs.

Files may be transferred to a destination in response to a request from a user at the destination or by a user of another device. A file transfer may take place at a time later than the request was received from a user. A scheduling module schedules the delivery of content over the network, taking into account the available bandwidth and storage capacity of the source and the destination, and the available bandwidth of the path through the network. In one embodiment, the scheduling module schedules a file transfer such that the transfer is complete by a deadline specified by a user. In one embodiment, the scheduling module resides at both the source device and the destination device. In other embodiments, the scheduling module resides at the source device only and at the destination device only.

Files may also be transferred to a destination without a request from a user. Such file transfers may occur in the context of a subscription or according to observations of user behavior. In one embodiment, a server or other source determines what content to transfer and when to initiate the transfer. In another embodiment, a pre-fetch module at the client monitors user behavior and determines content to be fetched to the client. Thus files may be transferred to the client without the knowledge or participation of the user.

In one embodiment of the invention, digital rights management (DRM) rules may be attached to files before transfer. DRM rules may include limitations on the transferability and accessibility of the transferred files. DRM rules are typically intended to enforce various rights in the files, including copyrights. The source of a transferred file may attach DRM rules to the data, and the destination preferably includes a software module configured to enforce the attached rules.

### BRIEF DESCRIPTION OF THE DRAWINGS

FIG. 1 is a block diagram of the preferred embodiment of an electronic network, according to the present invention;

FIG. 2 is a graph showing an example of bandwidth usage in the network of FIG. 1;

FIG. 3 is a block diagram of a portion of the electronic network of FIG. 1, according to the invention;

FIG. 4 is a block diagram of the central server of FIG. 1, according to the invention;

FIG. 5 is a block diagram of the client of FIG. 1, according to the invention;

FIG. 6 is a block diagram of the cache of FIG. 1, according to the invention;

FIG. 7 is a flowchart of method steps for delivery of content to the client, according to the invention;

FIG. 8 is a flowchart of method steps for delivery of content to a device other than the client, according to the invention;

FIG. 9 is a flowchart of method steps for delivery of content to the client, according to an alternate embodiment of the invention; and

FIG. 10 is a flowchart of method steps for pre-fetching content to the client, according to the invention.

### DETAILED DESCRIPTION OF THE PREFERRED EMBODIMENT

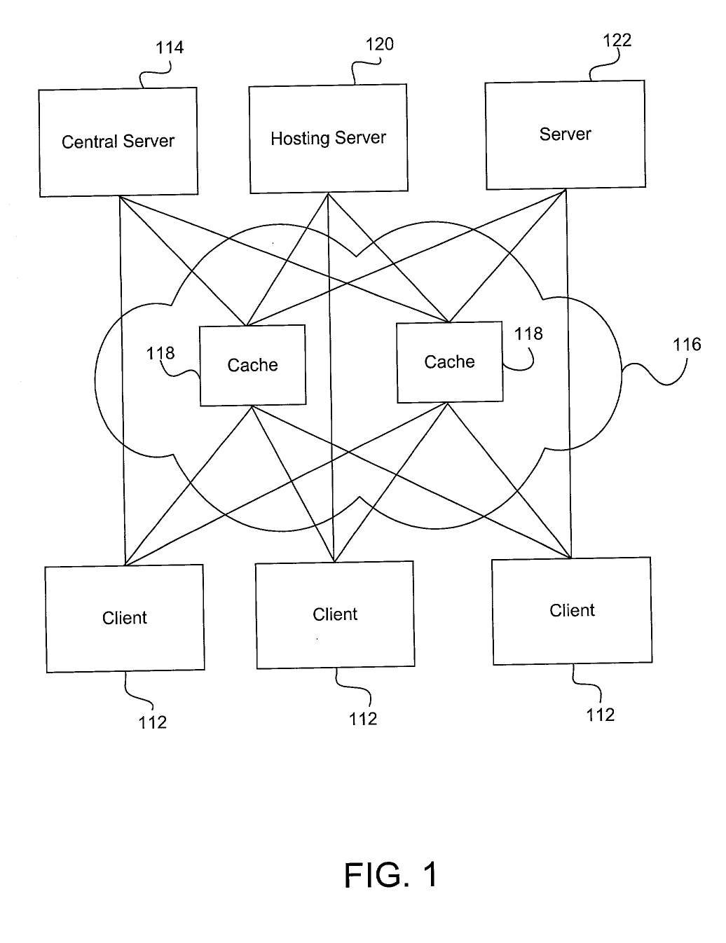

FIG. 1 is a block diagram of the preferred embodiment of an electronic network, according to the invention. A network 116 provides communication paths between clients 112, a central server 114, a hosting server 120, a server 122, and caches 118. Each client 112 preferably maintains a broadband communication path to network 116. The broadband communication path may be implemented as a Digital Subscriber Line (DSL) connection, a cable modem connection, or any other broadband communication type. Although only three clients 112, three servers 114, 120, and 122, and two caches 118 are shown in FIG. 1 for ease of discussion, network 116 preferably provides communication paths among a plurality of clients, a plurality of servers, and a plurality of caches. Each device in network 116 may be a source or destination for file transfers. For example, client 112 may act as a client for certain data, but may also act as a server for other data or for the same data at a different time.

Client 112 may be implemented as any type of electronic network device, including a general-purpose computer and a set-top box. Network 116 may be a local area network (LAN), a wide area network (WAN) such as the Internet, a home network, or any other type of electronic communication network. Cache 118 is preferably a general-purpose computer, but may be implemented as any other type of network communication device.

Central server 114, hosting server 120, and server 122 are preferably general-purpose computers that transfer data files via network 116 to clients 112; however, clients 112 may also transfer data files to servers 114, 120, and 122. File transfers between clients 112 and servers 114, 120, and 122 may pass through cache 118 and other parts of network 116. Other file transfers may originate from cache 118 to either clients 112 or servers 114, 120, and 122. Data files transferred over network 116 include audio data, video data, text data, software programs, or a combination; however all types of data files are within the scope of the invention.

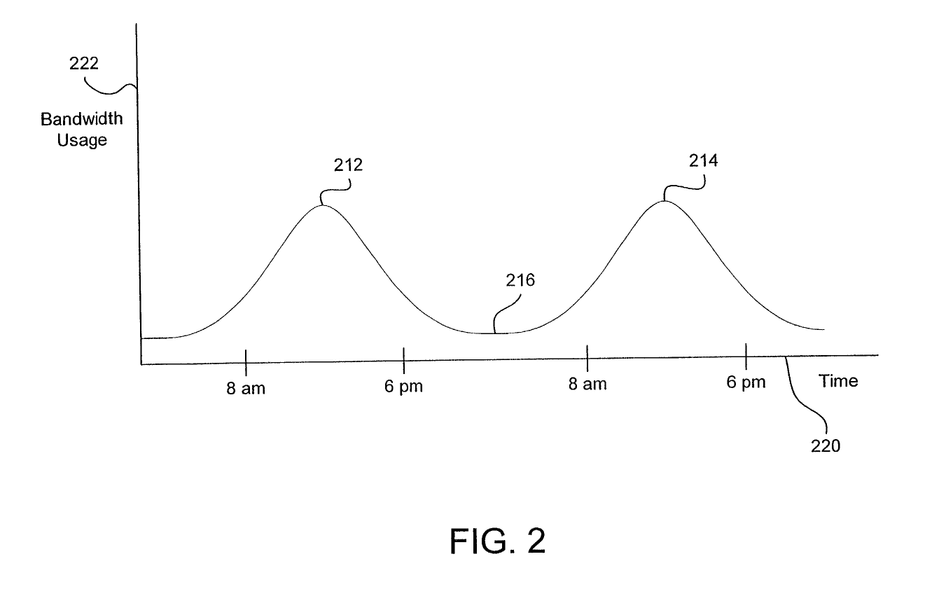

FIG. 2 is a graph showing an example of bandwidth usage in the network 116 of FIG. 1. The horizontal axis 220 shows time and the vertical axis 222 shows bandwidth usage. As shown, bandwidth usage varies over the course of a day. For example, bandwidth usage has peaks 212 and 214 between the hours of 8 am and 6 pm, which are typical business hours. Bandwidth usage has a minimum value 216 between the hours of 6 pm and 8 am, when many users are inactive. The area between peaks 212 and 214 represents unused available bandwidth. The invention preferably uses this available bandwidth to optimize file transfers, particularly large-sized files like motion video files.

FIG. 2 shows only one example of bandwidth usage; actual bandwidth usage in network 116 may vary differently over a period of time due to variations in network traffic. For instance, bandwidth usage may peak during the hours of 5 pm and 10 pm, when residential users are typically most active. The scheduling module of the invention preferably schedules transfers of large data files to take advantage of low levels of bandwidth usage.

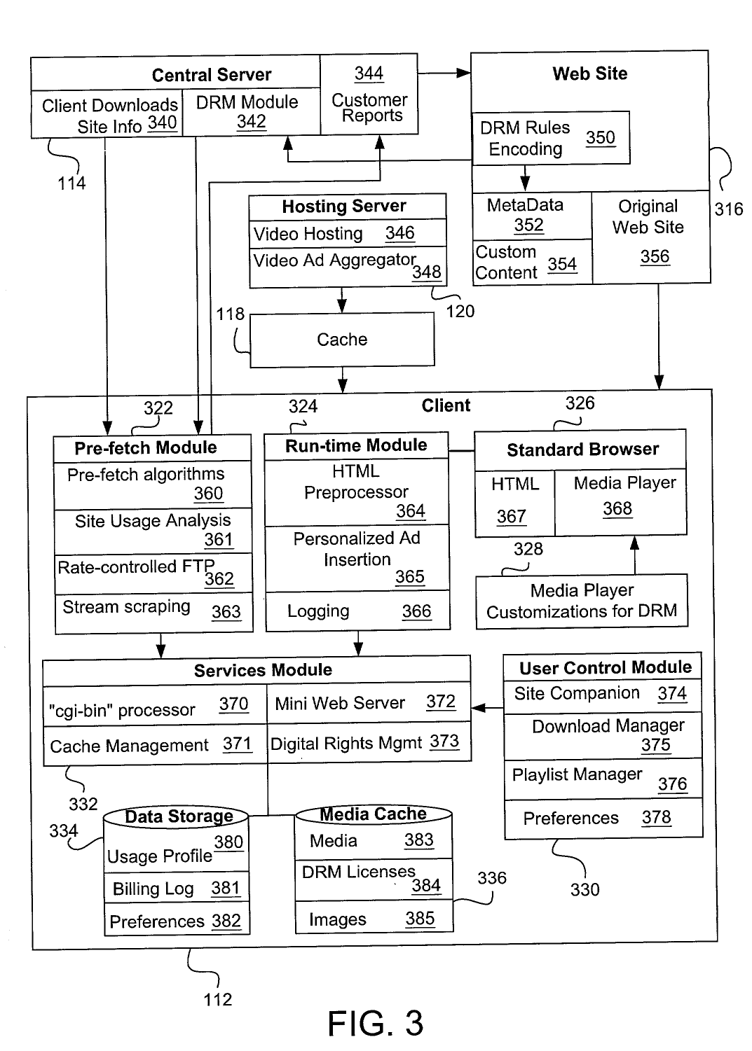

FIG. 3 is a block diagram of a portion of the electronic network of FIG. 1, according to the invention. Central server 114 communicates with a web site 316 and a client 112. Web site 316 is hosted on server 122, and communicates with client 112, providing web pages where a user at client 112 may select content (data files) to be delivered by a deadline. Web site 316 includes, but is not limited to, an original web site 356, a Digital Rights Management (DRM) rules encoding module 350, metadata 352, and custom content 354. DRM rules encoding module 350 provides rules restricting use of content that are attached to the content as metadata 352. Other metadata 352 are attached to files as information to facilitate processing of the files by client 112. Custom content 354 includes aspects of web site 316, such as high-quality video, that are not available in original web site 356. Such custom content 354 may be delivered to client 112, and displayed to a user from storage at client 112 when the user accesses web site 316.

Central server 114 includes, but is not limited to, client downloads and site information 340, a DRM module 342, and customer reports 344. The DRM module 342 receives data from DRM rules encoding module 350 of web site 316 and provides licenses for content to client 112. Central server 114 receives usage data from client 112 from which it generates customer reports 344 that are communicated to web site 316. The client downloads and site information 340 are provided to client 112, and include updates and patches for client software.

The electronic network of FIG. 3 also includes a hosting server 120, which provides video hosting 346 (as an Application Service Provider (ASP)), and a video advertisement aggregator 348. Hosting server 120 communicates via cache 118 with client 112. Cache 118 may be implemented as a home gateway or overlay network. Although not shown in FIG. 3, central server 114 and web site 316 may also communicate via cache 118 with client 112. For instance, if cache 118 is implemented as a home gateway, all communications outside of the home network will pass through cache 118. The home gateway is able to store content and deliver it to a plurality of clients on the home network.

Video advertisement aggregator 348 preferably includes high quality video advertisements that are delivered to client 112 and stored there. When a user at client 112 accesses web site 316, instead of receiving an advertisement from hosting server 120, the video advertisement stored at client 112 is inserted into the web page displayed to the user. Thus advertisers are able to provide high-quality video advertisements without the limitations of streaming them to client 112.

Client 112 includes, but is not limited to, a pre-fetch module 322, a run-time module 324, a standard browser 326, a media player customization module 328, a user control module 330, a services module 332, a data storage 334, and a media cache 336. Pre-fetch module 322 contains pre-fetch algorithms 360 that are configured to request delivery of content without a specific request from the user. The pre-fetch requests are based on preferences selected by a user and by analysis of the user's behavior (site usage analysis 361). Pre-fetch module 322 also contains a rate-controlled FTP module 362 for controlling the rate of data transfers to client 112. One embodiment of the rate-controlled FTP module is disclosed in co-pending U.S. patent application entitled “System and Method for Controlling Data Transfer Rates Through a Network.” A stream scraping module 363 stores data files streamed to client 112, and if errors occurred during streaming, requests the data files to be streamed again until a complete copy is stored.

Run-time module 324 includes, but is not limited to, an HTML preprocessor 364, a personalized advertisement insertion module 365, and a logging module 366. In one embodiment, run-time module 324 is implemented as a proxy server, and in an alternate embodiment is implemented as a browser plug-in. HTML preprocessor 364 modifies HTML content before sending it to browser 326, for example changing pointers for content on a server to a pointer for content stored in media cache 336. The personalized advertisement insertion module 365 inserts advertisements from media cache 336 into web pages displayed by standard browser 326. The logging module 366 is a postprocessor filter that extracts data such as web site identity, time of day, and page load times. The logging module 366 then sends this data to a data storage 334. Standard browser 326 includes, but is not limited to, Hyper Text Markup Language (HTML) functionality 367 and a media player 368 for playback of data files (such as a movie) stored in media cache 336. The media player 368 uses media player customizations for DRM 328 to enforce DRM rules attached to content.

Services module 332 includes, but is not limited to, a “cgi-bin” processor 370, a mini web server 372, a cache management module 371, and a digital rights management (DRM) module 373. Mini web server 372 receives Hypertext Transfer Protocol (HTTP) requests from standard browser 326 and if the requested content is present in media cache 336, serves out the content from media cache 336. If the requested content is not in media cache 336, mini web server 372 forwards the request to web site 316, and preferably stores the received content in media cache 336. Mini web server 372 also supports communication with central server 114.

The cache management module 371 manages the content in media cache 336. The cache management module 371 determines the size of media cache 336, the organization of the content in media cache 336, and implements cache replacement algorithms. In deciding whether to replace content, a cache replacement algorithm may consider the importance of the content, the lifetime of the content, and the nature of the request for the content. For instance, content specifically requested by a user would take precedence over content pre-fetched based on observations of user behavior. In one embodiment, services module 332 includes a cache monitoring module (not shown) that monitors usage of pre-fetched data in media cache 336.

Media cache 336 includes, but is not limited to, media 383, DRM licenses 384, and images 385. Data storage 334 includes, but is not limited to, a usage profile 380, a billing log 381, and preferences 382. Usage profile 380 contains information about which web sites the user visits and how often. Billing log 381 contains a record of all browsing and pre-fetching activity. The user selects preferences 382. User control module 330 provides a user interface for control of various functionalities of client 112. A site companion 374 lists content of web site 316 that is available for delivery, and allows the user to enter a delivery deadline. A download manager 375 shows all of the pending deliveries and their status. The user is able to stop, resume, or cancel any delivery using download manager 375. A playlist manager 376 shows a list of media available in media cache 336 and allows the user to create categories, delete and rename files, and export the list to media player 368 of standard browser 326. Preferences 378 allows the user to control the amount of disc space allocated to media cache 336, to set up pay-per-view parameters, and indicate preferred times for delivery of content.

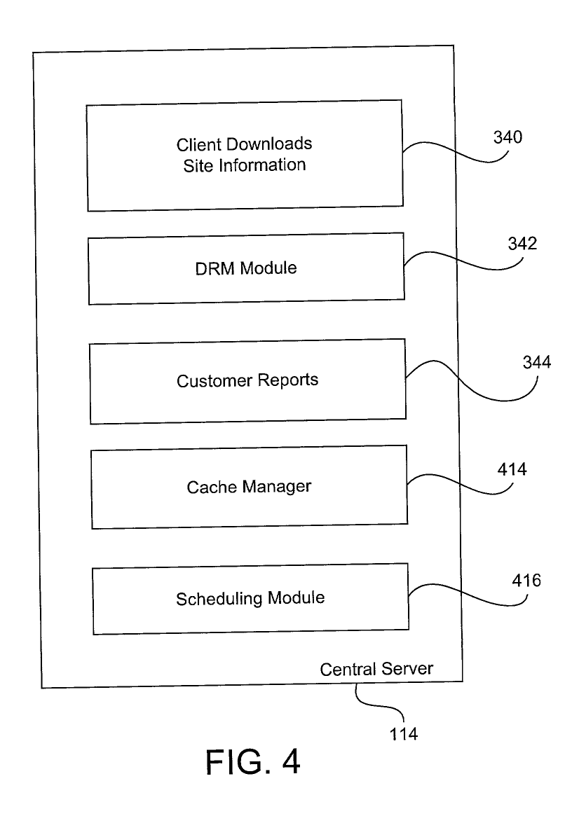

FIG. 4 is a block diagram of the central server 114 of FIG. 1, according to the invention. Central server 114 includes, but is not limited to, client downloads and site information 340, DRM module 342, customer reports 344, a cache manager 414, and a scheduling module 416. Client downloads 340 includes any types of data files (content). Some data files in client downloads 340 may be static in nature, such as audio recordings or movies. Other data files in client downloads 340 may be dynamic in nature, such as weather forecasts and current news reports. Some dynamic content may change on a regular basis such as daily or weekly and other dynamic content may change on a random basis.

Client downloads 340 may include audio recordings, video recordings such as movies and documentaries, photographs, advertisements including text and graphics, text-based documents, news reports, traffic reports, weather forecasts, sports scores, and sports highlights. Client downloads 340 may also include software programs, for example training materials, tutorials, games, browser plug-ins, and screen savers.

Cache manager 414 organizes and categorizes client downloads 340. Cache manager 414 may categorize files in client downloads 340 in a variety of ways, for example by file type, subject matter, or author. Cache manager 414 may also monitor client downloads 340 for files that need to be updated, and initiate the updating process.

Central server 114 typically receives requests for the transfer of a file or files from client downloads 340 to other devices in network 116, for instance client 112 or cache 118. Scheduling module 416 processes requests for file transfers, and may also process file transfers in accordance with a subscription arrangement. Scheduling module 416 uses information about the available bandwidth and storage at central server 114, a destination device, and a path through network 116 to determine an appropriate time to begin delivering content.

Scheduling module 416 is configured to schedule and manage file transfers between source devices, such as central server 114, and destination devices, such as client 112. Scheduling module 416 is able to simultaneously manage file transfers from multiple sources to multiple receivers. Central server 114, hosting server 120, server 122, and other source devices in network 116 have files to be transferred to one or more of clients 112 or other destination devices by specified deadlines. Scheduling module 416 determines the time and rate for these transfers to meet the time constraints. Scheduling module 416 takes into account the processing power, available bandwidth, and available storage of a source device, a destination device, and the path through network 116 between the two devices.

In the preferred embodiment, scheduling module 416 resides at both client 112 and central server 114, and may also reside on cache 118. In other embodiments, scheduling module 416 resides at central server 114 only, or resides at client 112 only. Scheduling module 416 may also reside in a control server (not shown) that maintains information about the capabilities of devices and paths in network 116.

Scheduling module 416 produces optimum schedules for delivery of data files (content) to a destination device, where what is optimum depends upon various optimization goals. Examples of optimization goals are maximizing the total content that is transferred within its deadline, maximizing the number of requests for file transfers that are met within their deadlines, minimizing any delay incurred beyond a deadline, or minimizing the cost. To produce an optimum schedule for a file transfer, scheduling module 416 considers the amount of data to be transferred, priority of the transfer relative to other transfers, available bandwidth at the source device, the destination device, and in the network, the cost of the available bandwidth, and available storage capacity at the destination device and any intermediate caches. One embodiment for scheduling module 416 is further discussed in the related co-pending application “System and Method for Scheduling Data Transfers Through a Network,” which is incorporated by reference.

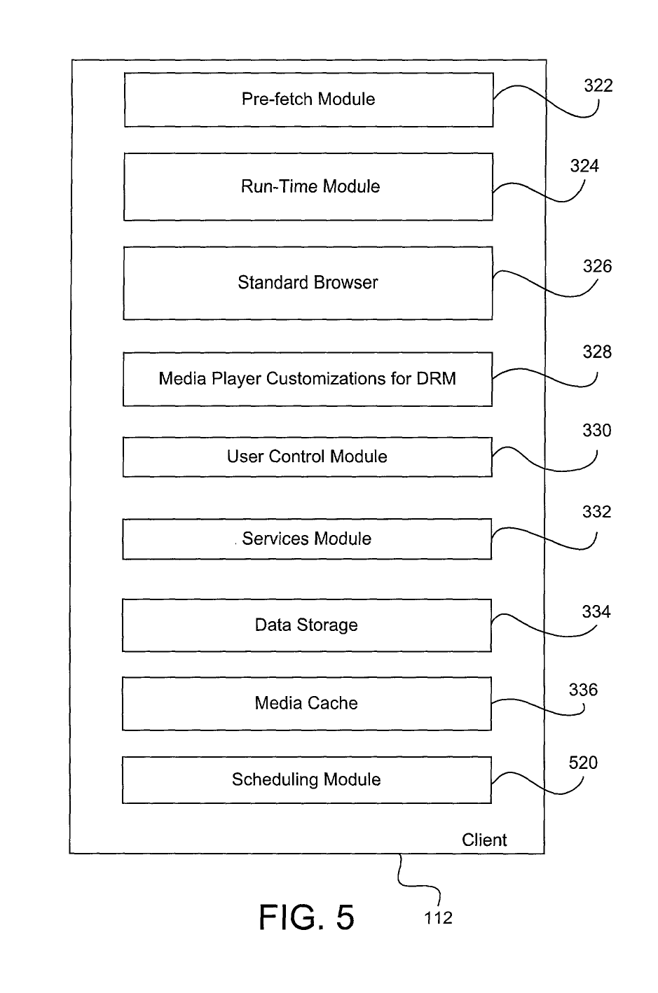

FIG. 5 is a block diagram of the client 112 of FIG. 1, according to the invention. The FIG. 5 embodiment of client 112 includes, but is not limited to, pre-fetch module 322, run-time module 324, standard browser 326, media player customizations for DRM 328, user control module 330, services module 332, data module 334, media cache 336, and a scheduling module 520.

Scheduling module 520 processes requests for file transfers made by the user and has functionality equivalent to scheduling module 416 discussed above. Scheduling module 520 coordinates with scheduling module 416 of central server 114 to process file transfers from central server 114 to client 112. For example, if the user subscribes to a daily news report, scheduling module 520 coordinates the file transfer and saves the news report to media cache 336 in conjunction with services module 332. In another example, the user may receive an email message with an attachment pointing to the location of a data file too large to be a reasonable attachment. The attachment may provide instructions to scheduling module 520 to request delivery of the data file from a certain source, perhaps hosting server 120, by a certain deadline. Scheduling module 520 sends the request to hosting server 120 and stores the received data file in media cache 336. Scheduling module 520 may then issue an alert to the user indicating that the file has arrived and its filename.

Media cache 336 may include data files that were delivered not by a request of the user, but were pre-fetched from central server 114 by pre-fetch module 322. This pre-fetched data may include advertisements that are typically displayed as part of a web page. When the user views a certain web page, instead of downloading the advertisement from an ad server and inserting it into the web page, a pre-fetched advertisement from media cache 336 is inserted into the web page. Since the advertisement is stored locally, it may contain high quality motion graphics and sound without a significant load time.

Pre-fetch module 322 identifies content to pre-fetch based on user preferences or monitoring of user behavior. For example, the user may visit web sites about international travel. Pre-fetch module 322 may then identify advertisements for airlines and hotels as appropriate files to pre-fetch to client 112. Pre-fetch module 322 requests the appropriate files from a server. Services module 332 may monitor how often pre-fetched content is accessed and provide feedback to pre-fetch module 322.

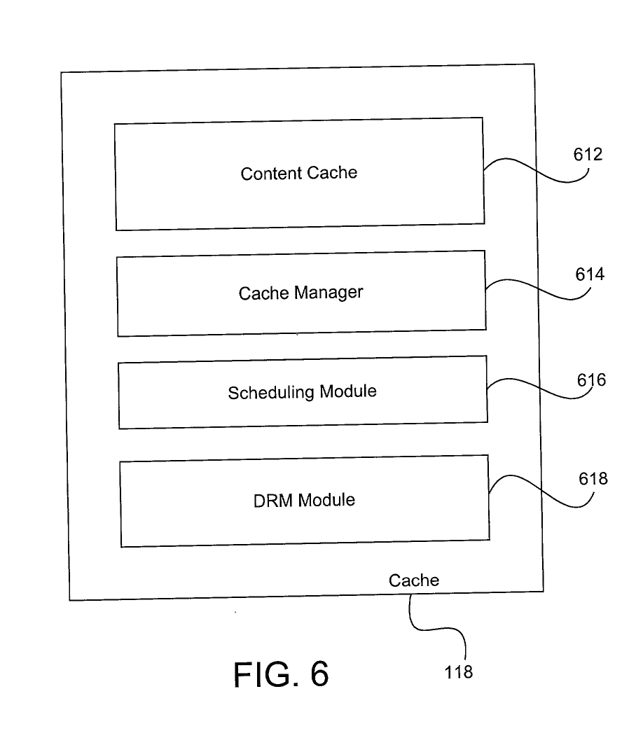

FIG. 6 is a block diagram of cache 118 of FIG. 1, according to the invention. The FIG. 6 embodiment of cache 118 is a general-purpose computer including, but not limited to, a content cache 612, a cache manager 614, a scheduling module 616, and an optional DRM rules encoding module 618. Content cache 612 and cache manager 614 have the same functionality as media cache 336 and cache management 371 of client 112 (FIG. 3). In this embodiment, cache 118 may be a source for data files that may be transferred to client 112 or central server 114.

In some instances, a particular file may reside in central server 114 and cache 118. If client 112 requests that file, scheduling module 416 of central server 114 may determine that instead of transferring the file from itself, transferring the file from cache 118 would be more efficient. Central server 114 may then send instructions to scheduling module 616 of cache 118 to deliver the requested file to client 112 by the deadline, if any. If central server 114 does transfer a file through cache 118 to client 112, cache manager 614 preferably stores a copy of the file in content cache 612. Thus cache 118 is now a source for other transfers of that file.

DRM rule encoding module 618 may attach DRM rules to certain content before it is transferred to client 112 or another chosen location. As described above, DRM rules are typically restrictions on the transferability and use of files containing protected material, such as copyrighted material. Some DRM rules, such as read-only, may be permanently attached to files and other DRM rules, such as limits on the number of times a file may be accessed, may depend upon choices made by the user at client 112. For example, a user may decide to pay for viewing a movie three times instead of purchasing the movie.

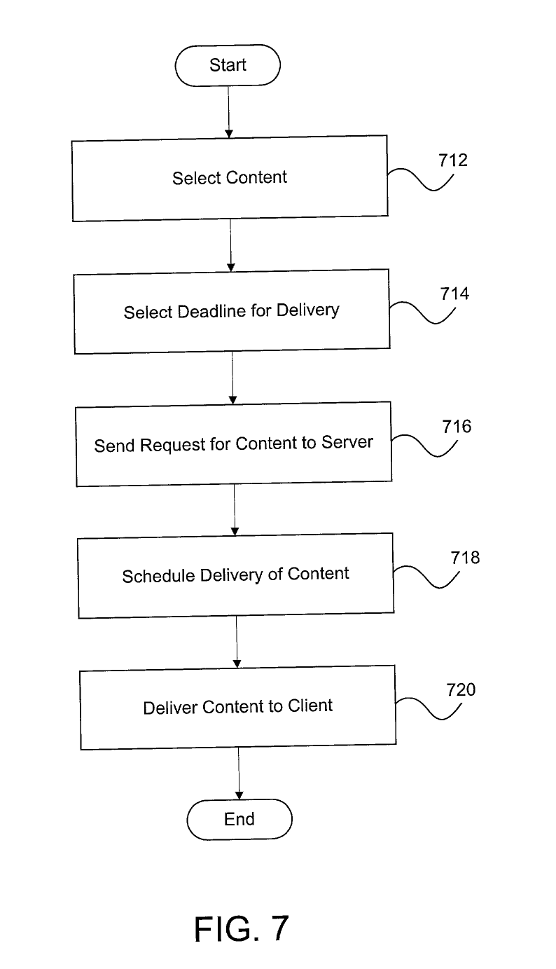

FIG. 7 is a flowchart of method steps for delivery of content to the client 112, according to the invention. In step 712, a user at client 112 selects content for delivery. The user may select content by choosing from a display of available content on a web site viewed with standard browser 326. In step 714, the user selects a deadline for delivery of the content. The deadline may be any length of time, but typically may be a number of hours or a number of days after the time of the request.

In step 716, scheduling module 520 of client 112 sends a request for the selected content to central server 114. The request includes the identity of the selected content and the delivery deadline. In step 718, scheduling module 416 of central server 114 receives the request and schedules delivery of the content. At the appropriate time as determined by scheduling module 416, in step 720 central server 114 delivers the content to client 112. Scheduling module 416 determines the appropriate time to ensure delivery by the deadline.

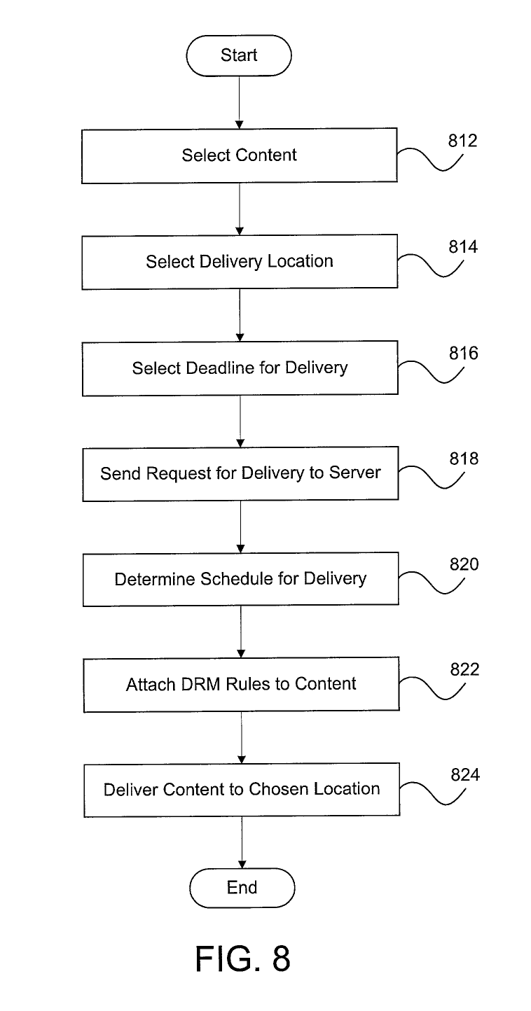

FIG. 8 is a flowchart of method steps for delivery of content to a device other than client 112, according to the invention. In the FIG. 8 embodiment, a user at client 112 selects content for delivery to a location that is not client 112. For example, the user may purchase a movie as a gift for delivery to the recipient's home computer or set-top box.

In step 812, the user at client 112 selects content, for example a movie with DRM rules attached, which is located at central server 114. In step 814, the user selects a location for the delivery of the content. The location may be identified in a variety of ways, for example an email address or Internet Protocol (IP) address. In step 816, the user selects a deadline for delivery of the content to the chosen location.

Then, in step 818, scheduling module 520 of client 112 sends a request to central server 114 for delivery of the content. In step 820, scheduling module 416 of central server 114 determines a schedule for delivery of the content to the chosen location. Then, in step 822, scheduling module 416 in conjunction with DRM module 342 attaches appropriate DRM rules to the content. For a purchased movie, the DRM rules may prevent copying or transferring the file. In step 824, at an appropriate time as determined by scheduling module 416, central server 114 delivers the content (movie) to the chosen location (recipient's home computer or set-top box). The chosen location preferably has a functionality equivalent to client 112.

In one embodiment, a user of a handheld electronic device, for example a personal digital assistant or mobile telephone, sends a request to central server 114 for delivery of content to client 112. For instance, the user may access a movie rental web site using a personal digital assistant and request that a movie be delivered to his or her home computer (or set-top box) by a deadline. The server for the web site then schedules delivery of the movie from an appropriate source to be completed by the deadline.

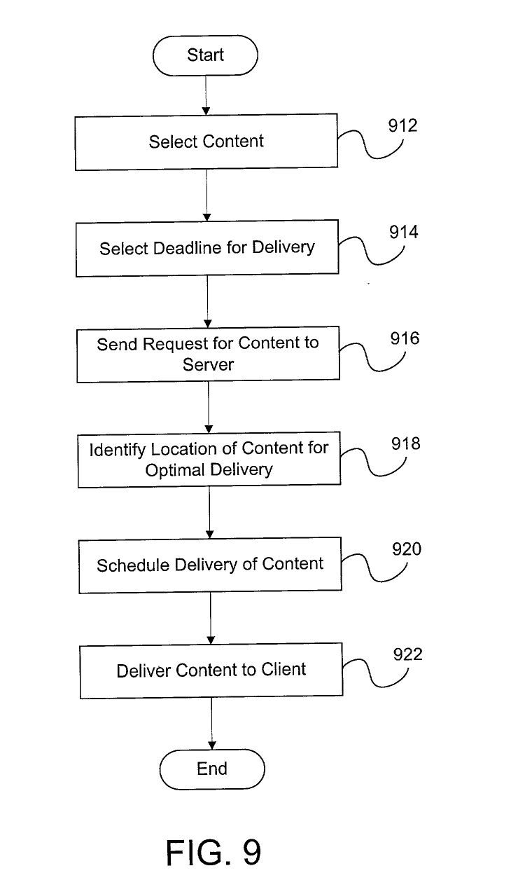

FIG. 9 is a flowchart of method steps for delivery of content to the client 112, according to an alternative embodiment of the invention. In step 912, a user at client 112 selects content for delivery. In step 914, the user selects a deadline for delivery of the content to client 112. In step 916, scheduling module 520 of client 112 sends a request for delivery of the selected content by the deadline to central server 114. Then, in step 918, scheduling module 416 of central server 114 identifies a present location of the content (source) such that delivery of the content to client 112 is optimized. The choice of location may be based on several factors, such as proximity of a source to client 112 and available bandwidth between the source and client 112. Possible sources for the content may include central server 114, cache 118, or other servers and devices in network 116.

Once an appropriate source has been identified, then in step 920, scheduling module 416 of central server 114 schedules the delivery of the content and sends instructions to the source device. In step 922, the source device delivers the content to client 112 such that the transfer is complete by the deadline.

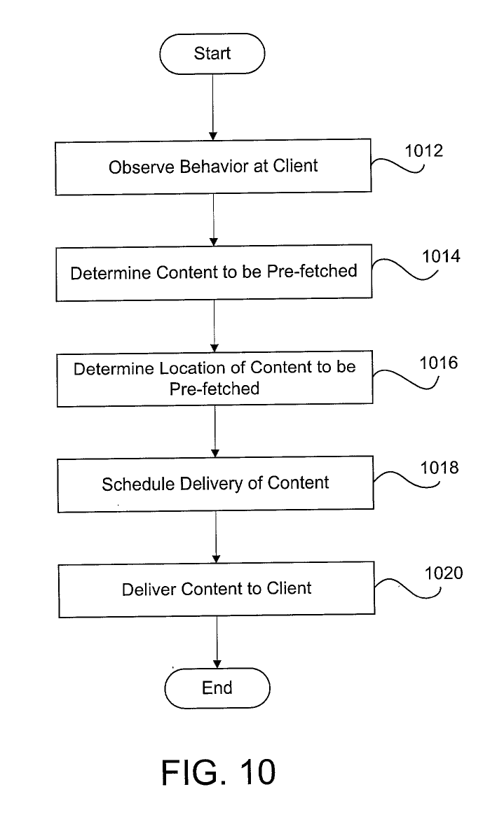

FIG. 10 is a flowchart of method steps for pre-fetching content to client 112, according to the invention. In step 1012, pre-fetch module 322 observes a user's behavior at client 112, for example monitoring which web sites the user visits often. Then, in step 1014, pre-fetch module 322 determines content to be pre-fetched to client 112. Pre-fetch module 322 may observe that certain advertisements are inserted in certain web pages that the user often views. The advertisement file sent to client 112 with the web page may include indicators that a high-resolution version of the advertisement is available.

In step 1016, pre-fetch module 322 determines the location of the content to be pre-fetched. For the web advertisement, the location information of the high-resolution version may be included in the advertisement file sent with the web page. Then, in step 1018, the delivery of the content is scheduled. Pre-fetch module 322 sends instructions to scheduling module 520 of client 112 to send a request for the content to the appropriate source, with or without a deadline. In step 1020, the source of the content delivers the content to client 112 and scheduling module 520 manages the receipt of the pre-fetched content and stores it in media cache 336.

The invention has been explained above with reference to a preferred embodiment. Other embodiments will be apparent to those skilled in the art in light of this disclosure. For example, the present invention may readily be implemented using configurations other than those described in the preferred embodiment above. Additionally, the present invention may effectively be used in conjunction with systems other than the one described above as the preferred embodiment. Therefore, these and other variations upon the preferred embodiments are intended to be covered by the present invention, which is limited only by the appended claims.

1. A method for transferring files among devices in a network, comprising:
requesting via a destination device a transfer of a file from a source device;
scheduling the transfer of the file from the source device to the requesting destination device, wherein the transfer is scheduled to be completed by a deadline; and
transferring the file from the source device to the requesting destination device, wherein the file transfer from the source device to the requesting destination device is complete by the scheduled deadline.

2. The method of claim 1, wherein scheduling comprises determining available bandwidth between the source device and the destination device.

3. The method of claim 1, wherein scheduling comprises determining available storage at the destination device.

4. The method of claim 1, wherein a user at the destination device specifies the deadline.

5. The method of claim 1, further comprising identifying the file to be transferred from the source device.

6. The method of claim 5, wherein a user at the destination device identifies die file to be transferred from the source device.

7. The method of claim 5, wherein a pre-fetch module at the destination device identifies the file to be transferred from the source device.

8. The method of claim 7, wherein the pre-fetch module is configured to identify files to be transferred based on observations of user behavior.

9. The method of claim 7, wherein the pre-fetch module is configured to identify files to be transferred according to predetermined user preferences.

10. The method of claim 1, wherein a device other than the destination device requests the file transfer from the source device.

11. A system for transferring files among devices in a network, comprising:
a destination device configured to send a request to a source device for transfer of a file from the source device to the destination device;
a source device configured to transfer the file to the destination device requesting the transfer of the file; and
a scheduling module configured to schedule the transfer of the file from the source device in response to the request by the destination device.

12. The system of claim 11, wherein the scheduling module schedules the transfer to be complete by a deadline.

13. The system of claim 12 wherein a user at the destination device specifies the deadline.

14. The system of claim 13, wherein a user at the destination device identifies the file to be transferred from the source device.

15. The system of claim 11, wherein the destination device comprises a pre-fetch module configured to identify the file to be transferred from the source device.

16. The system of claim 15, wherein the pre-fetch module is configured to identify files to be transferred based on observations of user behavior.

17. The system of claim 15, wherein the pre-fetch module is configured to identify files to be transferred according to predetermined user preferences.

18. The system of claim 11, wherein the scheduling module schedules the transfer of the file based on available bandwidth at the source device and the destination device.

19. The system of claim 11, wherein the scheduling module schedules the transfer of the file based on available storage at the destination device.

20. The system of claim 11, wherein the scheduling module schedules the transfer of the file based on available bandwidth in the network.

21. The system of clam 11, wherein the scheduling module resides at the source device.

22. The system of claim 11, wherein the scheduling module resides at the destination device.

23. The system of claim 11, wherein the scheduling module resides in both the destination device and the source device.

24. The system of claim 11, wherein the scheduling module resides in a cache device in the network.

25. The system of claim 11, wherein the scheduling module resides in the destination device, the source device, and a cache device in the network.

26. A method for transferring files among devices in a network, comprising:
identifying a file via a destination device, wherein the file is to be transferred to the destination device;
selecting a source device to transfer the file; and
scheduling the transfer of the file from the selected source device to the destination device.

27. (canceled)

28. The method of claim 26 wherein the the file is identified according to a user subscription.

29. The method of claim 26, wherein the destination device identifies the file according to observations of user behavior at the destination device.

30. The method of claim 26, further comprising completing transfer of the file from the source device to the destination device by a deadline.

31. (canceled)

32. The method of claim 30, wherein a user at the destination device causes the destination device to identify the file to be transferred from the source device to the destination device.

33. The method of claim 30, wherein a user at the destination device in the network determines the deadline for completion of the transfer of the file.

34. The method of claim 26, wherein scheduling comprises determining available bandwidth at the source device and the destination device.

35. The method of claim 26, wherein scheduling comprises determining available bandwidth in the network.

36. The method of claim 26, wherein the source device is a server.

37. The method of claim 26, wherein the source device is a cache device in the network.

38. A system for delivering content in a network, comprising:
a client configured to send to a server a request for delivery of the content;
a scheduling module configured to determine a schedule for delivery of the content from the server to the client requesting the delivery of the contents and
the server configured to deliver the content to the requesting client in response to the request and according to the schedule.

39. The system of claim 38, wherein the content is delivered to the client without a user being present at the client during delivery.

40. The system of claim 38, wherein the scheduling module resides at the server.

41. The system of claim 38, wherein the scheduling module resides at the client.

42. The system of claim 38, wherein the scheduling module resides in a control server in the network.

43. The system of claim 42, wherein the control server monitors bandwidth and storage resources in the network and provides bandwidth and storage resources data to the scheduling module.

44. The system of claim 38, wherein the server attaches digital rights management rules to the content prior to delivery.

45. The system of claim 38, wherein the client comprises a digital rights management module configured to implement digital rights management rules attached to the content.

46. The system of claim 38, wherein the client is a general-purpose computer.

47. The system of claim 38, wherein the client is a set-top box.

48. The system of claim 38, wherein the request for delivery comprises a deadline for delivery, the scheduling module determines a schedule for delivery to meet the deadline, and the server completes delivery of the content to the client by the deadline.

49. The system of claim 38, wherein the client comprises a pre-fetch module configured to pre-fetch content from the server.

50. The system of claim 49, wherein the pre-fetched content is stored in a cache at the client.

51. The system of claim 50, wherein the client comprises a mini web server configured to receive a request for content from a browser, determine that the requested content resides in the cache as pre-fetched content, and send the requested content from the cache to the browser instead of requesting the content from the server.

52. The system of claim 50, wherein specifically requested content is stored in the cache at the client.

53. The system of claim 52, wherein the client comprises a cache management module configured to determine the size of the cache.

54. The system of claim 52, wherein the client comprises a cache management module configured to organize the content in the cache.

55. The system of claim 52, wherein the client comprises a cache management module configured to implement cache replacement algorithms to add or remove content from the cache.

56. The system of claim 50, wherein the client comprises a cache management module configured to monitor usage of the pre-fetched content in the cache.

57. A system for transferring files among devices in a network, comprising:
means for requesting at a destination device a transfer of a file from a source device;
means for scheduling the transfer of the file from source device to the destination device to be completed by a deadline; and
means for transferring the file from the source device to the destination device, whereby the file transfer is complete by the deadline.

58. A system for transferring files among devices in a network, comprising:
a plurality of servers configured to deliver content to the devices in the network;
a plurality of clients configured to receive content from the plurality of servers; and
a scheduling module configured to determine schedules for delivery of content from the plurality of servers to the plurality of clients, the schedules being based on available bandwidth at the plurality of servers, available bandwidth at the plurality of clients, and available bandwidth in the network between the plurality of servers and clients.
